(19) United States
(12) Patent Application Publication
(10) Pub. No.: US 2014/0282279 A1
(43) Pub. Date: Sep. 18, 2014

(54) INPUT INTERACTION ON A TOUCH SENSOR COMBINING TOUCH AND HOVER ACTIONS

(71) Applicant: CIRQUE CORPORATION, Salt Lake City, UT (US)

(72) Inventor: Richard D. Woolley, Orem, UT (US)

(73) Assignee: CIRQUE CORPORATION, Salt Lake City, UT (US)

(21) Appl. No.: 14/208,345

(22) Filed: Mar. 13, 2014

Related U.S. Application Data
(60) Provisional application No. 61/782,530, filed on Mar. 14, 2013.

(51) Int. Cl. G06F 3/0488

(52) U.S. Cl. CPC G06F 3/04883
USPC 715/863

(57) ABSTRACT

A system and method for defining a gesture to be any combination of touch and hover actions, the touch and hover actions being combined in any order and any number of discrete touch and hover actions that define a single gesture or a series of gestures.

### BACKGROUND OF THE INVENTION

1. Field of the Invention

This invention relates generally to touch sensors that are capable of performing both touch and proximity sensing, wherein a single gesture may combine a touch action and a non-touch or hover action in a single gesture.

2. Description of Related Art

It is useful to describe one embodiment of touchpad technology that can be used in the present invention. Specifically, the capacitance-sensitive touchpad technology of CIRQUE® Corporation can be used to implement the present invention when combined with a display, such as a liquid crystal display (LCD). The CIRQUE® Corporation touchpad is a mutual capacitance-sensing device and an example is illustrated in FIG. 1. The touchpad can be implemented using an opaque surface or using a transparent surface. Thus, the touchpad can be operated as a conventional touchpad or as a touch sensitive surface on a display, and thus as a touch screen.

In this touchpad technology of CIRQUE® Corporation, a grid of row and column electrodes is used to define the touch-sensitive area of the touchpad. Typically, the touchpad is a rectangular grid of approximately 16 by 12 electrodes, or 8 by 6 electrodes when there are space constraints. Interlaced with these row and column electrodes is a single sense electrode. All position measurements are made through the sense electrode. However, the row and column electrodes can also act as the sense electrode, so the important aspect is that at least one electrode is driving a signal, and another electrode is used for detection of a signal.

In more detail, FIG. 1 shows a capacitance sensitive touchpad 10 as taught by Cirque® Corporation includes a grid of row (12) and column (14) (or X and Y) electrodes in a touchpad electrode grid. All measurements of touchpad parameters are taken from a single sense electrode 16 also disposed on the touchpad electrode grid, and not from the X or Y electrodes 12, 14. No fixed reference point is used for measurements. Touchpad sensor control circuitry 20 generates signals from P,N generators 22, 24 that are sent directly to the X and Y electrodes 12, 14 in various patterns. Accordingly, there is a one-to-one correspondence between the number of electrodes on the touchpad electrode grid, and the number of drive pins on the touchpad sensor control circuitry 20.

The touchpad 10 does not depend upon an absolute capacitive measurement to determine the location of a finger (or other capacitive object) on the touchpad surface. The touchpad 10 measures an imbalance in electrical charge to the sense line 16. When no pointing object is on the touchpad 10, the touchpad sensor control circuitry 20 is in a balanced state, and there is no signal on the sense line 16. There may or may not be a capacitive charge on the electrodes 12, 14. In the methodology of CIRQUE® Corporation, that is irrelevant. When a pointing device creates imbalance because of capacitive coupling, a change in capacitance occurs on the plurality of electrodes 12, 14 that comprise the touchpad electrode grid. What is measured is the change in capacitance, and not the absolute capacitance value on the electrodes 12, 14. The touchpad 10 determines the change in capacitance by measuring the amount of charge that must be injected onto the sense line 16 to reestablish or regain balance on the sense line.

The touchpad 10 must make two complete measurement cycles for the X electrodes 12 and for the Y electrodes 14 (four complete measurements) in order to determine the position of a pointing object such as a finger. The steps are as follows for both the X 12 and the Y 14 electrodes:

First, a group of electrodes (say a select group of the X electrodes 12) are driven with a first signal from P, N generator 22 and a first measurement using mutual capacitance measurement device 26 is taken to determine the location of the largest signal. However, it is not possible from this one measurement to know whether the finger is on one side or the other of the closest electrode to the largest signal.

Next, shifting by one electrode to one side of the closest electrode, the group of electrodes is again driven with a signal. In other words, the electrode immediately to the one side of the group is added, while the electrode on the opposite side of the original group is no longer driven.

Third, the new group of electrodes is driven and a second measurement is taken.

Finally, using an equation that compares the magnitude of the two signals measured, the location of the finger is determined.

Accordingly, the touchpad 10 measures a change in capacitance in order to determine the location of a finger. All of this hardware and the methodology described above assume that the touchpad sensor control circuitry 20 is directly driving the electrodes 12, 14 of the touchpad 10. Thus, for a typical 12×16 electrode grid touchpad, there are a total of 28 pins (12+16=28) available from the touchpad sensor control circuitry 20 that are used to drive the electrodes 12, 14 of the electrode grid.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes on the same rows and columns, and other factors that are not material to the present invention.

Although the CIRQUE® touchpad described above uses a grid of X and Y electrodes and a separate and single sense electrode, the sense electrode can also be the X or Y electrodes by using multiplexing. Either design will enable the present invention to function.

The underlying technology for the CIRQUE® Corporation touchpad is based on capacitive sensors. However, other touchpad technologies can also be used for the present invention. These other proximity-sensitive and touch-sensitive touchpad technologies include electromagnetic, inductive, pressure sensing, electrostatic, ultrasonic, optical, resistive membrane, semi-conductive membrane or other finger or stylus-responsive technology.

### BRIEF SUMMARY OF THE INVENTION

In a preferred embodiment, the present invention is a system and method for defining a gesture to be any combination of touch and hover actions, the touch and hover actions being combined in any order and involving number of discrete touch and hover actions that may define a single gesture or a series of gestures.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of a capacitance-sensitive touchpad as made by CIRQUE® Corporation and which can be operated in accordance with the principles of the present invention.

FIG. 2 is a profile illustration of a touch and hover sensor and a gesture performed as the finger is moved using both a touch and a hover gesture.

FIG. 3A is a perspective view of a detection volume above a touch and hover sensor.

FIG. 3B is a profile view of a detection volume above a touch and hover sensor.

FIG. 4 is a perspective view of a stylus used with a touch and hover touch screen.

FIG. 5 is a perspective view of a touch sensor being separate from two hover sensors.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

It should be understood that use of the term “touch sensor” throughout this document may be used interchangeably with “capacitive touch sensor”, “touch panel”, “proximity sensor”, “touch and proximity sensor”, “touchpad” and “touch screen”. In addition, the term “portable electronic appliance” may be used interchangeably with the “mobile telephone”, “smart phone” and “tablet computer”.

Upon making contact with the surface of a touch sensor it is possible to provide input to a sensor that may be interpreted as various commands or as input to control various functions. For example, the input may be in the form of controlling a cursor on a graphical user interface. Another function may include but should not be considered as limited to the performance of a gesture. A gesture may be any action that is detected by a touch sensor that is then correlated with some action or function to be performed by a program.

Various criteria may be used to determine what gesture is being performed. For example, the number of fingers that are touching the surface of the touch sensor, the timing of making contact, and movement of the fingers being tracked are all factors that may differentiate between gestures.

However, with proximity sensitive touch sensors, there is also a detection volume (a three dimensional space) that may be above the touch sensor that may also be capable of detecting and/or tracking one or more objects before contact is made. This data may also be available depending upon the capabilities of the touch sensor. This data may be characterized as coming from off-surface data, proximity or hover information. Thus, hovering is defined as one or more fingers being disposed over the touch sensor so that they are detectable but not in contact with it. The term hover does not imply that the finger or fingers are stationary, but only removed from contact.

The first embodiment of the present invention is directed to the concept of combining touch and hover data that is collected by a single touch sensor that includes the ability to collect proximity or hover information as well as touch information. Combining touch and hover data may result in an additional level of input information to provide input to any computing device.

There are several examples that may be used to illustrate the concepts of the first embodiment. FIG. 2 is provided as an illustration of snapshots showing movement of a single finger as it progresses from a first location 40 to a final location 46.

FIG. 2 shows a touch and hover sensor 30. The touch and hover sensor 30 may be a linear design that can objects in two dimensions, such as along the long axis 48 either on a surface 34 and above it in a detection volume. Alternatively, the touch and hover sensor 30 may be a standard design that detects objects on the surface 34 in two dimensions, as well as above the surface.

In this embodiment showing a single gesture, the finger 32 begins at the location 40. The user moves the finger 32 along the surface 34 of the touch and hover sensor 30 in a touch action until reaching the location 42. The finger 32 is then lifted off the touch and hover sensor 30 but continues movement in the same direction in a hover action. The finger 32 then makes contact with the touch and hover sensor 30 at location 44 in another touch action. The finger 32 then continues to move along the surface 34 until reaching the location 46 in the touch action. The finger 32 is then stopped and removed from the touch and hover sensor 30.

What is important is that the touch and hover sensor 30 was aware of the location of the finger 32 at all times. This means that the finger 32 was being tracked while on the surface 34 of the touch and hover sensor 30, and while above it. The touch actions and the hover actions may be combined into a single gesture, or they may be seen as discrete and unrelated events.

In an alternative embodiment, a plurality of fingers 32 may be used at the same time. The fingers 32 may all be on the surface 34 of the touch and hover sensor 30 at the same time, all above the touch and hover sensor, or some of the fingers 32 may be on the surface while other fingers are also above it.

Gestures with one or more fingers are not limited to simply being on, above, or on and above the touch and hover sensor 30. In another alternative embodiment, the fingers 32 may also change position during a gesture. For example, fingers 32 may start above the touch and hover sensor 30 in a hover action and then move to the surface 34 in a touch action. Similarly, the fingers 32 may start on the touch and hover sensor 30 in a touch action and then be lifted off in a hover action. Alternatively, some fingers 32 may start on the surface 34 in a touch action while others start above in a hover action, and then one or more fingers may switch positions.

In another alternative embodiment shown in FIG. 3A, a gesture may not only be defined by movement that places the fingers 32 on and then takes them off the touch and hover sensor 30, but by movement while on or above the surface 34. Movement may be detected above the touch and hover sensor 30 by detecting movement in a detection volume 36 which may be defined as a three dimensional volume of space above the touch and hover sensor 30. It should be understood that the exact dimensions of the three-dimensional space of the detection volume 36 are not shown precisely. The detection volume 36 shown should not be considered as limiting to a specific shape, but is only for illustration purposes only. The shape of the detection volume 36 is more likely to be a truncated sphere such as is shown in profile in FIG. 3B, with the truncated portion of the sphere defining the touch and hover sensor 30. However, the detection volume 36 shown in FIG. 3B should also not be considered as limiting to an actual shape of the detection volume.

Gestures that include movement may include such things as spreading fingers apart or moving fingers so that they are all together. Spreading fingers apart may be performed as a touch action or as a hover action, or as a combination of both.

Any function may be assigned to these gestures. For example, if the fingers move from a position where all the fingers 32 are touching to a position where all the fingers are spread apart, this gesture may be interpreted as a zoom function. The zoom function may be to zoom-in or zoom-out, with one motion defining a zoom-out function and the opposite movement defining the zoom-in function.

Other gestures may include but are not limited to grasping, pushing, pulling, spreading apart, lifting, putting down, movements of the fingers alone, movements of the fingers combined with movement of a hand, movement of the hand and not the fingers, or any other recognizable gesture that may be performed in the detection volume 36 with a hand and its fingers.

A gesture may also include repeated movements. For example, the gesture may include a touch action, then a hover action, then a touch action again. Alternatively, the gesture may begin with a hover action, a touch action, and then a hover action again. What should be understood is that a touch action and a hover action may be combined in any order and in any combination to create a unique gesture.

In another embodiment of the present invention, a gesture is defined as the use of momentum. For example, performing a push or pull gesture on an image, file or within an application may be combined with momentum data as recognized by the touch and hover sensor 30 for improved levels of accuracy of momentum or inertial movement. For example, a user may perform a zoom-in gesture using all fingers 32 being spread apart and then bringing them together. This movement may be combined with the added movement of the hand moving away from the touch and hover sensor 30. This movement of the hand may be done at the same time as the zoom-in gesture and cause the zoom-in gesture to continue for a period of time even after the hand and fingers are no longer within the detection volume 36 of the touch and hover sensor 30. The period of time that the gesture may continue after the gesture has been terminated may be adjusted to give it a feeling of inertia that gradually stops instead of immediately terminating after the gesture is terminated.

In another embodiment of the present invention, a user may desire to perform a gesture defined as movement of a finger 32 across the touch and hover sensor 30. The touch and hover sensor 30 may be in an environment that makes it difficult to maintain contact with the touch and hover sensor for the entire length of the movement.

For example, consider a vehicle that contains touch and hover sensor 30 for providing input to control some function of a vehicle. Suppose that a user may desire to increase airflow of a fan. The fan may be controlled by a touch and hover sensor 30. The user may need to touch and then run a finger along the surface 34 of the touch and hover sensor 30 in order to increase the speed of the fan.

However, as the user runs a finger along the touch and hover sensor 30, the vehicle may hit a bump causing the finger to momentarily bounce and lose contact with the touch and hover sensor. However, the user may continue to move the finger 32 in the desired direction. Furthermore, the user may again make contact with the touch and hover sensor 30, never having interrupted the substantially linear movement of the finger. For example, the movement may be as shown in FIG. 2.

Although the linear movement of the finger 32 has been interrupted by the segment between locations 42 and 44, the touch and hover sensor 30 may interpret the gesture as uninterrupted movement in a single direction, even though the movement was both on and above the touch and hover sensor. After the gesture is completed at location 46, the speed of the fan will be whatever fan speed is associated with movement of a finger from location 42 to location 46. The gesture may be any combination of touches and hovers, and may begin with a touch or a hover.

In another embodiment of the present invention shown in FIG. 4, a touch and hover gesture may be used in combination with a stylus 52 on a touch and hover touch screen 50. The stylus 52 may be used with the touch and hover touch screen 50 to enable unique control of inking characteristics. For example, it may be desirable to change a thickness of inking on the touch and hover touch screen 50.

In order to perform a gesture with the stylus 52, the user may be able to lift the stylus 52 off of the touch and hover touch screen 50 and perform an action in the detection volume 36 over the touch and hover touch screen that changes a thickness of ink that will be virtually displayed. The user may then touch the touch and hover touch screen 50 with the stylus 52 and use the adjusted inking thickness.

Gestures that may be performed with the stylus 52 may include but should not be considered limited to twirling, moving back and forth, waving, pivoting, or any other recognizable movement of the stylus that may be distinguished from all other possible movements.

In another embodiment of the present invention, a user may desire to drag and drop an object shown on the touch and hover touch screen 50. The user may select the object by touching it, then lifting the finger off the touch and hover touch screen 50 and make contact in a different location, causing the object to move or to be dragged to the different location.

In another alternative embodiment of the invention shown in FIG. 5, a touch sensor 60 and a hover sensor 62 may be separate devices and may be more than one device. The sensors of the touch sensor 60 and a hover sensor 62 may even use different sensing technology to perform their functions. The sensors may be dedicated or they may share other functions.

Another aspect of the invention is that the hover sensor 62 may have a different operating volume than the touch sensor 60. For example, the hover sensor 62 may have a sensing volume to the right, the left, to the right and left, or even underneath the touch sensor 60.

In another aspect of the invention, the touch and hover touch screen 50 may provide visual feedback to the user when hovering before contact is made.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method of performing a touch and hover gesture using a touch and hover sensor, said method comprising:
providing a touch and hover sensor that is capable of detecting direct contact of at least one pointing object, and that is also capable of detecting a presence of the at least one pointing object in a detection volume adjacent to the touch and hover sensor;
performing a single gesture that includes at least one touch action by making direct contact by the at least one pointing object with touch and hover sensor, and which includes at least one hover action by moving the at least one pointing object into the detection volume;
combining the at least one touch action and the at least one hover action into the single gesture; and
performing at least one function associated with the single gesture.

2. The method as defined in claim 1 wherein the at least one pointing object is selected from the group of pointing objects that includes a stylus, a finger and a plurality of fingers.

3. The method as defined in claim 2 wherein the method further comprises selecting the hover action from the group of hover actions comprised of twirling, moving back and forth, waving, pivoting, grasping, pushing, pulling, spreading apart fingers, bringing fingers together, lifting, putting down, movements of the fingers alone, movements of the fingers combined with movement of a hand, movement of the hand and not the fingers.

4. The method as defined in claim 2 wherein the method further comprises selecting the touch action from the group of hover actions comprised of twirling, moving back and forth, waving, pivoting, grasping, pushing, pulling, spreading apart fingers, bringing fingers together, lifting, putting down, movements of the fingers alone, movements of the fingers combined with movement of a hand, movement of the hand and not the fingers.

5. The method as defined in claim 2 wherein the method further comprises the at least one hover action including movement of one or more fingers that are detectable by the touch and hover sensor.

6. The method as defined in claim 2 wherein the method further comprises the at least one touch action including movement of one or more fingers that are detectable by the touch and hover sensor.

7. The method as defined in claim 2 wherein the method further comprises the single gesture being comprised of at least one touch action being performed simultaneously with the at least one hover action.

8. The method as defined in claim 2 wherein the method further comprises selecting the touch action and the hover action of the stylus from the group of touch and hover actions comprised of twirling, moving back and forth, waving, and pivoting.

9. The method as defined in claim 2 wherein the method further comprises applying inertia to the at least one touch action or the at least one hover action such that the function being performed continues on for a period of time after the single gesture has been terminated.

10. A method of performing a touch and hover gesture using a touch and hover sensor, said method comprising:
providing a touch and hover sensor that is capable of detecting direct contact of at least one pointing object, and that is also capable of detecting a presence of the at least one pointing object in a detection volume adjacent to the touch and hover sensor;
performing a single gesture that includes at least one touch action by making direct contact by the at least one pointing object with touch and hover sensor, or which includes a hover action by moving the at least one pointing object into the detection volume, or a combination of at least one touch action and at least one hover action;
combining the at least one touch action and the at least one hover action if they were performed as part of the single gesture; and
performing at least one function associated with the single gesture.

11. The method as defined in claim 10 wherein the at least one pointing object is selected from the group of pointing objects that includes a stylus, a finger and a plurality of fingers.

12. The method as defined in claim 11 wherein the method further comprises selecting the hover action from the group of hover actions comprised of twirling, moving back and forth, waving, pivoting, grasping, pushing, pulling, spreading apart fingers, bringing fingers together, lifting, putting down, movements of the fingers alone, movements of the fingers combined with movement of a hand, movement of the hand and not the fingers.

13. The method as defined in claim 11 wherein the method further comprises selecting the touch action from the group of hover actions comprised of twirling, moving back and forth, waving, pivoting, grasping, pushing, pulling, spreading apart fingers, bringing fingers together, lifting, putting down, movements of the fingers alone, movements of the fingers combined with movement of a hand, movement of the hand and not the fingers.

14. The method as defined in claim 11 wherein the method further comprises the at least one hover action including movement of one or more fingers that are detectable by the touch and hover sensor.

15. The method as defined in claim 11 wherein the method further comprises the at least one touch action including movement of one or more fingers that are detectable by the touch and hover sensor.

16. The method as defined in claim 11 wherein the method further comprises the single gesture being comprised of at least one touch action being performed simultaneously with the at least one hover action.

17. The method as defined in claim 11 wherein the method further comprises selecting the touch action and the hover action of the stylus from the group of touch and hover actions comprised of twirling, moving back and forth, waving, and pivoting.

18. The method as defined in claim 11 wherein the method further comprises applying inertia to the at least one touch action or the at least one hover action such that the function being performed continues on for a period of time after the single gesture has been terminated.
